(19) United States
(12) Patent Application Publication
(10) Pub. No.: US 2020/0271218 A1
(43) Pub. Date: Aug. 27, 2020

(54) GEAR SELECTOR FOR A MOTOR VEHICLE AND METHOD FOR DETECTING AN ACTUATION OF A GEAR SELECTOR FOR A MOTOR VEHICLE

(71) Applicant: ZF Friedrichshafen AG

(72) Inventors: Daniel KREINEST, Neuenkirchen-Vörden (DE); Vitali FRIBUS, Quakenbrück (DE); Joachim SPRATTE, Osnabrueck (DE); Alexander KIRILENKO, Diepholz (DE)

(73) Assignee: ZF Friedrichshafen AG, Friedrichshafen (DE)

(21) Appl. No.: 16/063,815

(22) PCT Filed: Nov. 24, 2016
(86) PCT No.: PCT/EP16/78640

§ 371 Date: Jun. 19, 2018

(30) Foreign Application Priority Data
Dec. 21, 2015 (DE) DE102015226321.5

(51) Int. Cl. F16H 59/10; F16H 61/24; F16H 59/12; F16H 59/02

(52) U.S. Cl. CPC F16H 59/105; F16H 61/24; F16H 2059/048; F16H 59/0278; F16H 59/12

(57) ABSTRACT

The disclosure relates to a gear selection switch for a motor vehicle. The gear selection switch comprises at least one piezoelectric sensor element for detecting an actuation of the gear selection switch.

The present disclosure relates to a gear selection switch for a motor vehicle and a method for detecting an actuation of a gear selection switch for a motor vehicle.

U.S. Pat. No. 8,884,897 B2 describes an input device with a touch-sensitive display, which has at least one piezoelectric element for generating vibrations.

Against this background, the present disclosure provides an improved gear selection switch for a motor vehicle, as well as an improved method for detecting an actuation of a gear selection switch according to the main claims. Advantageous embodiments are included in the sub-claims and in the following description.

We shall introduce a gear selection switch for a motor vehicle, the gear selection switch having the following characteristic:

at least one piezoelectric sensor element for detecting an actuation of the gear selection switch.

A gear selection switch can involve a switch for selecting a gear position of an automatic transmission. A motor vehicle can involve, for example, a passenger car, a truck, or a commercial vehicle. A piezoelectric sensor element can involve an electronic component, which is configured to generate an electrical voltage as a sensor signal when a force is applied by a piezoelectric effect. The piezoelectric sensor element can be configured to detect a pressure, an acceleration, a tension or a force, depending on the embodiment.

The approach proposed here is based on the knowledge that it is possible to integrate in a gear selection switch a strokeless, for example, pressure-sensitive button for operating the gear selection switch, using a piezoelectric sensor element. As a result, the number of components of the gear selection switch can be reduced, thus reducing installation costs and the costs of producing the gear selection switch. Furthermore, by relinquishing mechanical buttons, it is possible to prevent noise generation, NVH (noise vibration harshness), for short. Moreover, by using such a sensor element, the gear selection switch can be implemented with a one-piece housing, which may prevent or at least impede dust and liquid from penetrating into the interior of the housing. Another advantage is the extension of the technological and design possibilities of the gear selection switch.

According to one embodiment, the piezoelectric sensor element can be configured to detect a compressive force as actuation. By means of said embodiment, the gear selection switch can be implemented with a pressure-sensitive button for actuating the gear selection switch.

It is advantageous when the gear selection switch has a control unit, which is configured to apply an AC voltage to the piezoelectric sensor element using a sensor signal provided by the piezoelectric sensor element, to produce a vibration of the piezoelectric sensor element. In addition, or alternatively, the control unit can be configured to emit an acoustic signal or a display signal using the sensor signal to display information, for example, via a screen integrated in the gear selection switch. A sensor signal can involve an electrical signal generated by applying a force on the piezoelectric sensor element. A control unit can involve an electrical device for processing and emitting signals. For example, the control unit can be configured to provide the AC voltage in response to the sensor signal. This embodiment can improve user-friendliness when actuating the gear selection switch.

According to a further embodiment, the gear selection switch can be implemented with a housing for receiving the piezoelectric sensor element. The housing can have at least one control panel for operating the gear selection switch. The piezoelectric sensor element can be arranged in the area of the control panel to detect a contact of the control panel as actuation. A control panel can involve a section of an outer surface of the housing. The control panel can be formed to be touched by a finger of a user, such as a thumb or index finger, to operate the gear selection switch. For example, the piezoelectric sensor element can be arranged on an inner wall surface of the housing located opposite of the control panel to detect the contact with the control panel. Depending on the embodiment, the piezoelectric sensor element can be implemented as part of the control panel. Alternatively, the piezoelectric sensor element can be implemented as a separate component, the piezoelectric sensor element being attached inside the housing in the area of the control panel, for example, by gluing or any other suitable joining process. The housing can also have a plurality of control panels, and each control panel can be combined with one respective piezoelectric sensor element. The control panels can be arranged at different places on the housing. This embodiment can considerably simplify the production of the gear selection switch. It also allows for an enclosed construction of the housing. As a result, it is possible to prevent dust and liquid from penetrating the gear selection switch.

For example, the control panel can be used as a parking button for selecting a parking position. In addition, or alternatively, depending on the embodiment, the control panel can be configured in the form of an unlock button for unlocking the gear selection switch or a switch button for switching to a manual switching mode. This allows the gear selection switch to control various functions of a vehicle transmission.

It is particularly advantageous when the control panel is recessed or raised in the housing. This allows for a simple and cost-effective production of the housing.

It is also advantageous when the control panel has a label. In addition, or alternatively, the control panel has a marking. This can improve the operability of the gear selection switch.

Here, the control panel can be used as a thumb key. As a result, the gear selection switch can be actuated with the thumb, for example, by pressing.

According to a further embodiment, the housing can have at least one display panel for displaying information. A display panel can involve a screen. For example, the display panel can be implemented as part of the housing. This embodiment allows information to be displayed on the gear selection switch. For example, the display panel can be configured to display the information using a display signal provided by the control unit.

Furthermore, the gear selection switch can comprise a support base for retaining the housing. To this end, the housing can be configured in the form of a curved handle with a finger support surface for placing a finger and, in addition, or alternatively, a hand support surface for placing a palm of the hand. Depending on the embodiment, the control panel can be implemented as part of the finger support surface or the hand support surface. For example, a support base can involve a plate-like or plinth-like element for mounting the gear selection switch in a motor vehicle. Depending on the embodiment, the housing can have a bending or curvature at least one place. This embodiment allows for an ergonomic design of the gear selection switch.

The support base and the housing can be produced in one piece. This can reduce the production costs of the gear selection switch. This also creates a stable connection between the support base and the housing.

Furthermore, the finger support surface can extend, at least partially, about a free end of the housing. For example, the finger support surface can extend along an upper side, a bottom side or a lateral surface of the free end connecting the upper side and the bottom side. This embodiment can also improve the ergonomics of the gear selection switch.

It is also advantageous when the control panel is arranged in the hand support surface adjacent to the support base. As a result, it can be avoided that a finger can accidental touch the control panel.

According to a further embodiment, the gear selection switch can have at least one additional piezoelectric sensor element for detecting a further actuation. For this purpose, the piezoelectric sensor element and the additional piezoelectric sensor element can be located or arranged at different places. By means of this embodiment, the gear selection switch can be implemented with multiple strokeless buttons.

The approach proposed here provides a method for detecting an actuation of a gear selection switch according to any one of the preceding embodiments. Said method comprises the following steps:

reading a sensor signal provided by the piezoelectric sensor element; and

evaluating the sensor signal to detect actuation.

For example, the method can be performed by a control unit described above.

The disclosure is described in more detail in an exemplary manner, using the enclosed drawings. It is shown:

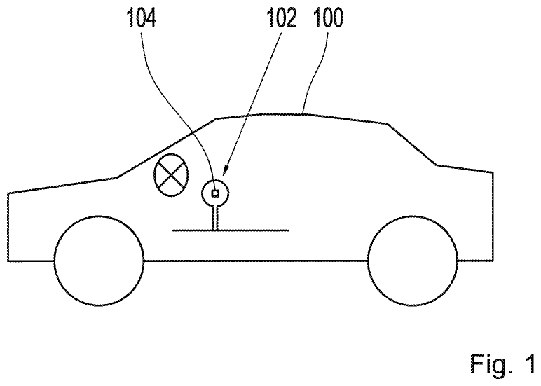

FIG. 1 shows a schematic representation of a motor vehicle having a gear selection switch according to a particular embodiment;

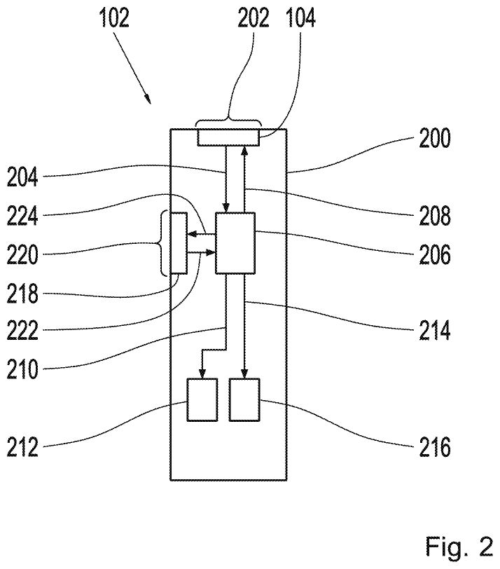

FIG. 2 shows a schematic representation of a gear selection switch according to a particular embodiment;

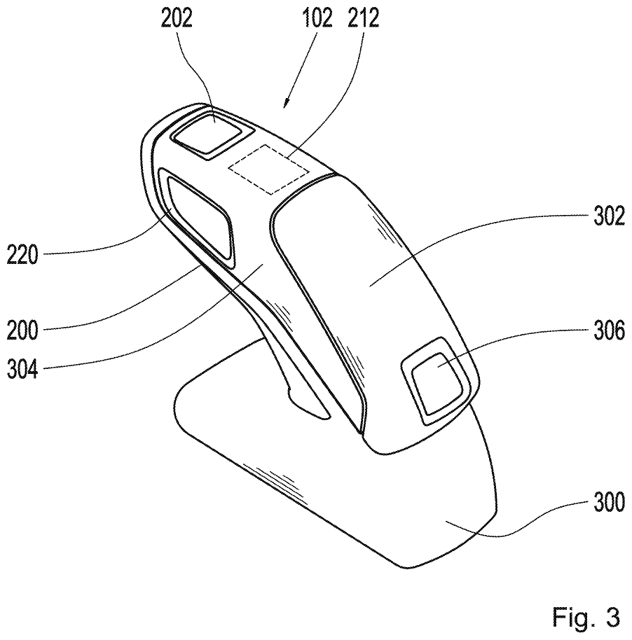

FIG. 3 shows a schematic representation of a motor vehicle having a gear selection switch according to a particular embodiment; and

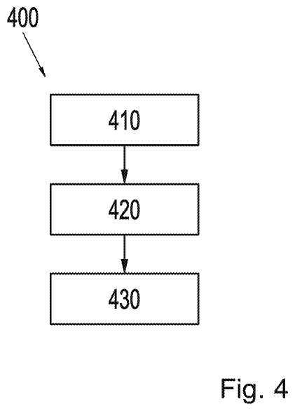

FIG. 4 a flow diagram of a method for detecting an actuation of a gear selection switch according to a particular embodiment.

In the following description of preferred embodiments of the present disclosure, the same or similar reference numerals are used for the elements depicted in different figures and having similar effects, without repeating the description of these elements.

FIG. 1 shows a schematic representation of a motor vehicle 100 having a gear selection switch 102 according to a particular embodiment. The gear selection switch is used for selecting a gear position of a transmission of the motor vehicle 100 and comprises a piezoelectric sensor element 104, which is configured to detect an actuation of the gear selection switch 102. Said gear selection switch is formed to be operated by a person, particularly a driver of the motor vehicle 100. For example, the piezoelectric sensor element 104 is implemented a piezo pressure sensor for detecting a compressive force applied with a finger on the gear selection switch 102.

FIG. 2 shows a schematic representation of a gear selection switch 102 according to a particular embodiment. For example, the gear selection switch 102 involves a gear selection switch described in FIG. 1. According to this embodiment, the gear selection switch 102 has a housing 200, in which the piezoelectric sensor element 104 is arranged. The housing 200 is formed with a control panel 202 for operating the gear selection switch 102 to be touched by a finger. The piezoelectric sensor element 104 is arranged inside the housing 200 adjacent to the control panel 202, to be able to detect the contact with the control panel 202. Furthermore, the piezoelectric sensor element 104 is configured to provide a touch-representing sensor signal 204 in response to the touch. An optional control unit 206 integrated in the gear selection switch 102 is configured to apply an AC voltage 208 to the piezoelectric sensor element 104 using the sensor signal 204. By means of the AC voltage, it is possible to cause a vibration of the piezoelectric sensor element 104. For the purpose of providing the AC voltage 208, the control unit 206 can be connected with a suitable energy source. As a result, the vibration of the piezoelectric sensor element 104 conveys to an operator of the gear selection switch 102 a haptic and/or acoustic feedback signal.

Depending on the embodiment, the control unit 106 is configured to provide in addition, or alternatively, to the AC voltage 208 a display signal 210 for displaying information by means of a display panel 212 or an acoustic signal 214 for playback by a speaker 216, depending on the sensor signal 204. According to this embodiment, the display panel 212 and the speaker 216 are integrated in the gear selection switch 102. For example, the display panel 212 can be implemented as part of the housing 200. Alternatively, the display panel 212 and the speaker 216 can involve external units arranged outside of the housing 200. For example, the display panel 212 can involve a central display or instrument cluster in the motor vehicle, and the speaker can involve a vehicle speaker.

According to the embodiment shown in FIG. 2, the gear selection switch comprises in an exemplary manner an additional piezoelectric sensor element 218, which is arranged on the housing 200 adjacent to an additional control panel 220. Said piezoelectric sensor element 218 is configured analogous to the piezoelectric sensor element 104 to provide an additional sensor signal 222 representing the contact of the additional control panel 220, in response to a contact of the additional control panel 220, and to send it to the control unit 206. Correspondingly, the control panel 206 is configured 206 to apply an additional AC voltage 224 to the additional piezoelectric sensor element 218, using the additional sensor signal 222, it is possible to cause a vibration of the additional piezoelectric sensor element 218, for the purpose of generating a haptic and/or acoustic feedback signal. Optionally, the control unit 206 is configured to provide the display signal 210 or the acoustic signal 214 or both signals 210, 214, using the additional sensor signals 222.

In an exemplary manner, both sensor elements 104, 218 are arranged at different wall sections of an inner side of the housing 200.

FIG. 3 shows a schematic representation of a gear selection switch 102 according to a particular embodiment, for example, a gear selection switch such as previously described in FIG. 1 and FIG. 2. According to this embodiment, the gear selection switch 102 is implemented with a support base 300 for retaining the housing 200. The housing 200 is a longitudinal finger-shaper handle having a slight curvature. One end of the housing 200 is connected with the support base 300. For example, the housing 200 and the support base 300 have a one-piece construction. By means of the support base 300, the gear selection switch 102 can be fixed in the motor vehicle.

A top side of the housing 200 facing away from the support base 300 functions as a hand support surface 302 for resting one palm of the hand. The hand support surface 302 ends at the support base 300. Furthermore, the hand support surface 302 is adjacent to a finger support surface 304 for resting a finger which, according to this embodiment extends to a great extent about a free end of the housing 200, as well as along a longitudinal side of the housing 200. At the same time, the control panel 202 and the display panel 212 are arranged adjacent to one another at the upper side of the housing 200 facing away from the support base 300, while the additional control panel 220 is arranged below the control panel 202 and display panel 212 at a sidewall of the housing 200 adjacent to the upper side. The display pane 212 involves, for example, a one-piece display with a viewing area.

According to the embodiment shown in FIG. 3, the gear selection switch 102 is implemented with three integrated piezo-pressure sensors as sensor elements, instead of mechanical buttons, i.e., instead of switches with mechanical contacts. For this purpose, the hand support surface 302 has an additional control panel 306, here a shift key for switching to a manual switching mode. The additional control panel 306 can be coupled with an additional piezoelectric sensor element for detecting a contact of the additional control panel 306, analogous to the two control panels 202, 220. For example, the additional piezoelectric sensor element can be arranged on an inner wall of the housing 200 located opposite of the additional control panel 306 and can be also connected with the control unit of the gear selection switch 102. According to FIG. 3, the additional control panel 306 is arranged adjacent to a bottom edge of the housing 200, which adjoins the support base 300.

The embodiment shown in FIG. 3 depicts in an exemplary manner the three control panels 202, 220, 306 configured as key-shaped recesses in an outer wall of the housing 200. Alternatively, the three control panels can also be configured in the form of elevations. For example, the two control panels 202, 220 are implemented as pressure-sensitive, strokeless buttons to be actuated by a thumb or index finger.

As an option, the control unit provides acoustic or haptic feedback when touching one of the three control panels.

According to a further embodiment, the gear selection switch 102 is implemented as a single component with integrated electronic switching element in the form of the piezoelectric sensor elements.

FIG. 4 shows a method 400 for detecting an actuation of a gear selection switch according to a particular embodiment. For example, the method 400 can be performed in connection with one of the preceding gear selection switches described in FIGS. 1 to 3. In particular, the method can be performed, for example, by a control unit described in FIG. 2. In the method 400, the sensor signal provided by the piezoelectric sensor element is read in step 410. In an additional step 420, the sensor signal is evaluated to detect the actuation of the gear selection switch.

According to an optional embodiment, in step 430, an AC voltage is generated at the sensor element, using the sensor signal. Optionally, in step 430, either additionally or alternatively, a display signal for displaying information or an acoustic signal using the sensor signal is generated.

If an embodiment includes an “and/or” link between a first characteristic and a second characteristic, this can mean that, according to one configuration, the embodiment has the first characteristic, as well as the second characteristic and, according to another configuration, it has only the first characteristic or only the second characteristic.

### REFERENCE SYMBOLS

100 Motor vehicle
102 Gear selection switch
104 Piezoelectric sensor element
200 Housing
202 Control panel
204 Sensor signal
206 Control unit
208 AC voltage
210 Display signal
212 Display panel
214 Acoustic signal
216 Speaker
218 Further piezoelectric sensor element
220 Additional control panel
222 Additional sensor signal
224 Additional AC voltage
300 Support base
302 Hand support surface
304 Finger support surface
306 Additional control panel
400 Method for detecting an actuation of a gear selection switch
410 Step of reading
420 Step of evaluating
430 Step of generating

1. A gear selection switch for a motor vehicle, the gear selection switch comprising:
a piezoelectric sensor element for detecting an actuation of a gear selection switch.

2. The gear selection switch according to claim 1, wherein the piezoelectric sensor element is configured to detect a compressive force as actuation.

3. The gear selection switch according to claim 1, further comprising a control unit, configured to apply an AC voltage to the piezoelectric sensor element to cause a vibration of the piezoelectric sensor element in response to a sensor signal provided by the piezoelectric sensor element.

4. The gear selection switch according to claim 1, further comprising a housing for receiving the piezoelectric sensor element, the housing having at least one control panel for operating the gear selection switch, wherein the piezoelectric sensor element being is arranged in the area of the control panel to detect a contact of the control panel as actuation.

5. The gear selection switch according to claim 4, wherein the control panel is configured in the form of a parking button for selecting a parking position.

6. The gear selection switch according to claim 4, wherein the control panel is by a recess or an elevation in the housing.

7. The gear selection switch according to claim 4, wherein the control panel has a label and/or marking.

8. The gear selection switch according to claims 4, wherein the control panel is a thumb key.

9. The gear selection switch according to claim 4, wherein the housing has a display panel for displaying information.

10. The gear selection switch according claim 4, further comprising a support base for retaining the housing, wherein the housing is configured in the form of a curved handle with a finger support surface and/or a hand support surface for placing a palm of the hand, wherein the control panel is part of the finger support surface and/or hand support surface.

11. The gear selection switch according to claim 10, wherein the support base and the housing are produced in one piece.

12. The gear selection switch according to claim 10, wherein the finger support surface extends, at least partially, about a free end of the housing.

13. The gear selection switch according to claim 10, wherein the control panel is arranged in the hand support surface adjacent to the support base.

14. The gear selection switch according to claim 1, wherein the piezoelectric sensor element is a first piezoelectric sensor element, further comprising a second piezoelectric sensor element for detecting a further actuation, wherein the first piezoelectric sensor element and the second piezoelectric sensor element are located at different places.

15. A method for detecting an actuation of a gear selection switch, wherein the gear selection switch comprises a piezoelectric sensor element, said method comprising the following steps:
reading a sensor signal provided by the piezoelectric sensor element; and
evaluating the sensor signal to detect actuation.

16. The method according to claim 15, further comprising the step of providing, in response to a sensor signal provided by the piezoelectric sensor element, at least one of an AC voltage to the piezoelectric sensor element to cause a vibration of the piezoelectric sensor element, an acoustic signal, or a display signal.

17. The gear selection switch according to claim 1, further comprising a control unit configured to emit an acoustic signal in response to a sensor signal provided by the piezoelectric sensor element.

18. The gear selection switch according to claim 1, further comprising a control unit configured to emit a display signal for displaying information in response to a sensor signal provided by the piezoelectric sensor element.

19. The gear selection switch according to claim 4, wherein the control panel is configured in the form of an unlock button for unlocking the gear selection switch.

20. The gear selection switch according to claim 4, wherein the control panel is configured in the form of a switch button for switching to a manual switching mode.
